(19) United States
(12) Patent Application Publication
(10) Pub. No.: US 2002/0143861 A1
(43) Pub. Date: Oct. 3, 2002

(54) Method and apparatus for managing state information in a network data processing system

(75) Inventors: David Perry Greene, Ossining, NY (US); Edith Helen Stern, Yorktown Heights, NY (US); Barry Edward Willner, Briarcliff Manor, NY (US); Philip Shi-Lung Yu, Chappaqua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/824,460

(22) Filed: Apr. 2, 2001

(51) Int. Cl. G06F 15/16

(52) U.S. Cl. 709/203; 709/228; 709/217

(57) ABSTRACT

A method and apparatus for managing cookies in a data processing system. In response to a selected event, a cookie file is requested from a source in which the cookie file contains a set of cookies of previously obtained cookies and is associated with a user. The cookie file is received in which the cookies are to access Web sites.

### BACKGROUND OF THE INVENTION

1. Technical Field

The present invention relates generally to an improved data processing system and in particular to a method and apparatus for managing data. Still more particularly, the present invention provides a method and apparatus for managing cookies and other information in a network data processing system.

2. Description of Related Art

The Internet, also referred to as an “internetwork”, is a set of computer networks, possibly dissimilar, joined together by means of gateways that handle data transfer and the conversion of messages from protocols of the sending network to the protocols used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database. The HTML file also contains data, which may not be displayed at the browser. This “hidden” data may be used to store information or execute programs without the user's knowledge of the existence or purpose of the information or program.

A hidden data field, which may be included in the HTTP header of an HTML file, is a “cookie” data field. A cookie is an HTTP protocol header document element, which may be used to provide multiple data elements to the browser. In response to receiving an HTML file with a cookie, the browser may store the cookie data elements in a “cookies.txt” file, which is usually kept in the root directory for the browser. These cookie data elements are also referred to as “cookies”. Once a cookie is sent to the browser computer, the server expects the cookie to be returned in the HTTP header of subsequent messages sent from the browser to the server. The inclusion of the cookie in the HTTP header of messages from the browser is done without the user's awareness. In this manner, the operator of the server may identify repeat visitors to the server site.

A cookie provides a way for a Web site to keep track of a user's patterns and preferences and, potentially store the cookie on the user's computer. A cookie also provides for storage of state information. For example, a user may have a user ID and password stored in a cookie such that the user does not have to reenter this information the next time the user visits the Web site. The next time the user visits the Web site, the cookie is retrieved from the computer and used to login the user without requiring user input. Further other state information such as a history of pages visited may be maintained at the computer at which the user is located.

This information, however, is only good for the machine on which the user has entered the user ID and the password. Users are increasingly using multiple devices to access the Web. For example, a user may have a computer at work, a personal digital assistant, and a computer at home. Also, user may access other devices, such as a computer at a library, an airport kiosk, or a computer at a friends house. Cookies containing needed information and histories of Web sites visited are not present on these other devices.

Therefore, it would be advantageous to have an improved method and apparatus for managing state information.

### SUMMARY OF THE INVENTION

The present invention provides for a method and apparatus for managing state information, such as cookies, in a data processing system. In response to a selected event, a cookie file is requested from a source in which the cookie file contains a set of cookies of previously obtained cookies and is associated with a user. The cookie file is received in which the cookies are to access Web sites. In this manner a user may have access to the same state machine at different devices. This process may be applied to other state information, such as a history of Web sites previously visited, or book marks. The providing of this state information may be provided as a billed service to users.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a block diagram of a PDA in accordance with a preferred embodiment of the present invention;

FIG. 5 is a diagram illustrating management of state information in accordance with a preferred embodiment of the present invention;

FIG. 6 is a flowchart of a process used for requesting state information in accordance with a preferred embodiment of the present invention;

FIG. 7 is a flowchart of a process used for transferring updated state information in accordance with a preferred embodiment of the present invention;

FIG. 8 is a flowchart of a process used for retrieving a cookie in accordance with a preferred embodiment of the present invention;

FIG. 9 is a flowchart of a process used for processing a request for a cookie file in accordance with a preferred embodiment of the present invention; and

FIG. 10 is a flowchart of a process used for synchronizing state information in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 are connected to network 102. These clients 108, 110, and 112 maybe, for example, personal computers or network computers. Additionally, personal digital assistant (PDA) 114 also may communicate with network 102 through a wireless communications link. In the depicted example, server 104 provides data, such as boot files, operating system images, and applications to clients 108-112. Clients 108, 110, 112, and PDA 114 are clients to server 104. Network data processing system 100 may include additional servers, clients, and other devices not shown. For example, other mobile devices, such as a mobile phone or a laptop computer may be used in addition to or in place of a PDA.

The present invention provides a method, apparatus, and computer implemented instructions for allowing a user to move from device to device and maintain a state of interaction with a Web site. This convenience is provided by saving state information, such as cookies or navigation history in a server, such as server 104. When a user moves to another device, the state information associated with the user may be transmitted to the user at the new device so that the state of interaction present at the previous is made available at this new device.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

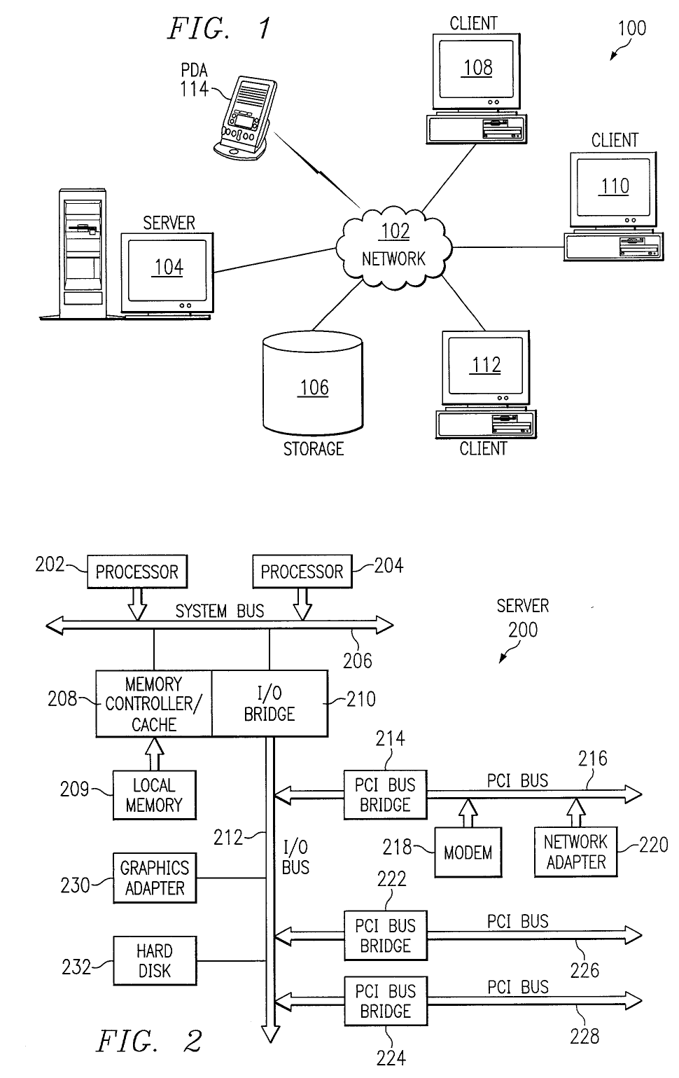

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

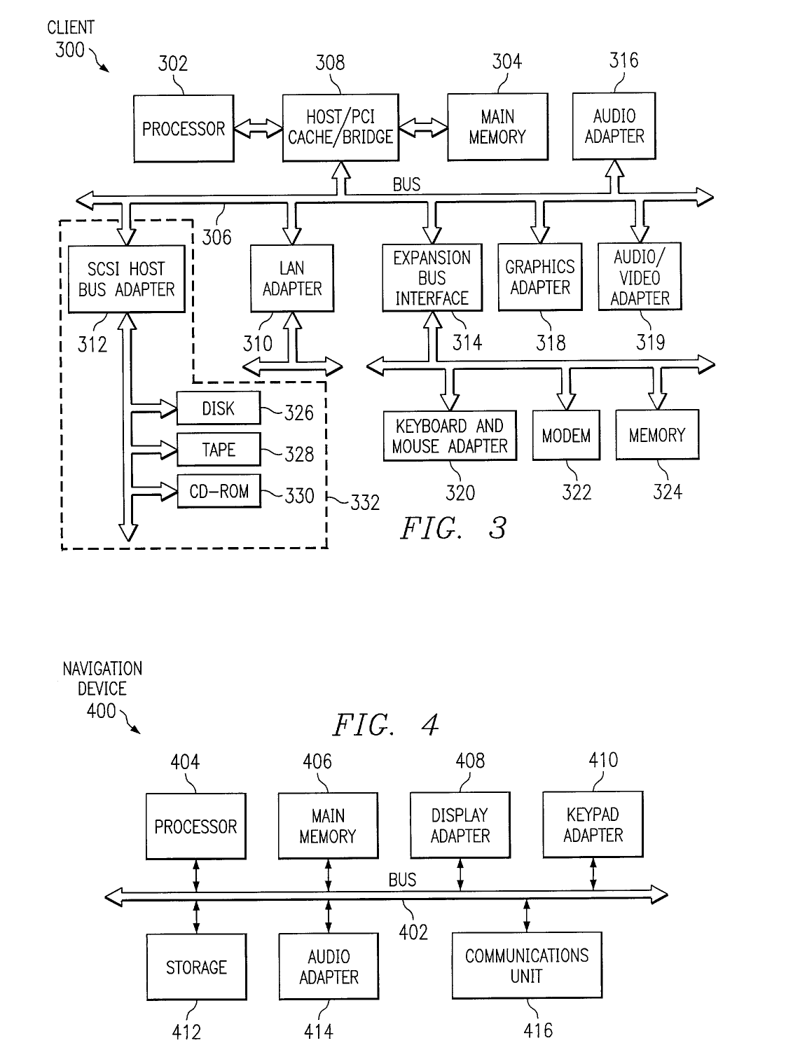

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Turning now to FIG. 4, a block diagram of a PDA is shown in accordance with a preferred embodiment of the present invention. PDA 400 is an example of a PDA, such as PDA 114 in FIG. 1 in which code or instructions implementing the processes of the present invention may be located. PDA 400 includes a bus 402 to which processor 404 and main memory 406 are connected. Display adapter 408, keypad adapter 410, storage 412, and audio adapter 414 also are connected to bus 402. Communications unit 416 provides a mechanism to establish a wireless connection between PDA 400 and another data processing system. This wireless connection may be made using a number of different protocols, such as Bluetooth wireless technology, which is a specification for small-form factor, low-cost, short range radio links between mobile PCs, mobile phones, and other portable devices. Of course any other wireless communications protocol or system may be used. Further, display adapter 408 also includes a mechanism to receive user input from a stylus when a touch screen display is employed.

An operating system runs on processor 404 and is used to coordinate and provide control of various components within PDA 400 in FIG. 4. The operating system may be, for example, a commercially available operating system such as Windows CE, which is available from Microsoft Corporation. Instructions for the operating system and applications or programs are located on storage devices, such as storage 412, and may be loaded into main memory 406 for execution by processor 404.

Those of ordinary skill in the art will appreciate that the hardware in FIG. 4 may vary depending on the implementation. Other internal hardware or peripheral devices, such as flash ROM (or equivalent nonvolatile memory) or optical disk drives and the like, may be used in addition to or in place of the hardware depicted in FIG. 4.

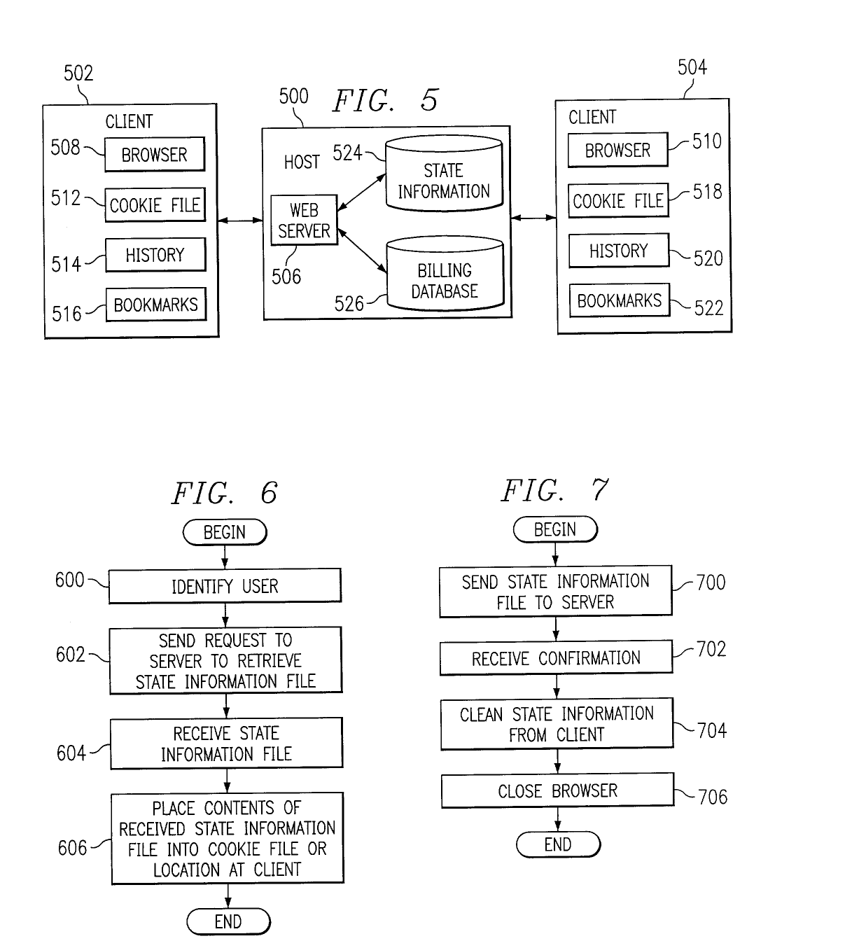

With reference now to FIG. 5, a diagram illustrating management of state information is depicted in accordance with a preferred embodiment of the present invention. Host 500 provides information and services to clients 502 and 504. In particular, host 500 contains Web server 506, which receives requests from browser 508 and browser 510. As illustrated, client 502 also includes cookie file 512, history 514, and bookmarks 516. Client 504 includes cookie file 518, history 520, and bookmarks 522. The history is a list of Web sites visited by a user and may include other historical information, such as time and date of visit and number of times that a site has been visited. The bookmarks are a list of URLs to different Web sites that a user has collected.

In these examples, the particular service provided by host 500 is state information, which is located in state information database 524. State information in these examples may be cookies, a history, bookmarks, user preferences, and prior sales transactions. State information may be stored using a number of mechanisms other than a database. Other types of data structures may be used as repository for this information. For example, a table or a three-dimensional array may be used to store this information.

When a user logs onto client 502, a process may be initiated by browser 508 to retrieve state information associated with the user from state information database 524. Web server 506 receives the request for state information from browser 508 and identifies appropriate state information from state information database 524 through an identification of the user. This identification is contained within the request and may be, for example, the user name or some other alias. The state information is then returned to browser 508 for use in accessing information. In this manner, a user at client 502 may easily access previously accessed Web sites in which the user saved logon information at another client, such as client 504, by retrieving state information, such as cookies.

When new state information is obtained, such as additional cookies or bookmarks, this state information may be returned to host 500 for storage. The initiation of this updating of state information may occur in response to various events. For example, the state information may be sent when a browser session terminates. On the other hand, the user may initiate the sending of the state information through some selected user input, such as a button or command for saving state information. The updates may take various forms, for example all of the state information may be sent to Web server 506 to replace state information in state information database 524. Alternatively, only new or updated state information may be sent to Web server 506 for use in updating state information within state information database 524.

If the user then moves to another device, such as client 504, browser 510 may initiate a request for state information from Web server 506. Current state information associated with the user may be returned by Web server 506 in response to this request. The state information received, in response to this request may then be used by the user at client 504. In this manner, a user may move from device to device and still be able to maintain the state of interaction with different Web sites. In some cases, transcoding of the state information may be required in order to make the information useful at another device.

Further, users may be billed for this service using billing database 526. Many mechanisms may be used to generate revenues for this service. For example, a user may be billed for each request and/or update to state information received by Web server 506. Alternatively, a user may be billed on a periodic basis, such as on a monthly basis for the service. State information collected within state information database 524 may be selected, aggregated, or merged for use by other parties. Further, this information may be offered to other parties for a fee. The state information may be stored in various formats depending on the implementation. For example, a markup language, such as extensible markup language (XML) may be used and may be preferable because it is recognized by many applications and devices. XML tags are used to define data, such as cookies, navagation, history, and bookmarks for use by the client.

Turning next to FIG. 6, a flowchart of a process used for requesting state information is depicted in accordance with a preferred embodiment of the present invention. The process illustrated in FIG. 6 may be implemented in an application, such as browser 508 in FIG. 5.

The process begins by identifying a user (step 600). A user may be identified using various mechanisms, such as, for example, a login and authentication screen or a smart card. A request is sent to a server to retrieve state information (step 602). The request includes the identification of the user. Next the state information is received by the application (step 604). The contents of the received state information is placed into a file or other location at a client for use in accessing Web sites (step 606) with the process terminating thereafter. For example, if the state information includes cookies, these cookies may be placed into a cookie file for the user at the client.

Referring now to FIG. 7, a flowchart of a process used for transferring updated state information is depicted in accordance with a preferred embodiment of the present invention. The process illustrated in FIG. 7 may be implemented in an application, such as browser 508 in FIG. 5. In these examples, the process in FIG. 7 is initiated in response to an event, such as a user input or a termination of the browser session.

The process begins by sending the state information to a server (step 700). This state information may be a copy of all of the state information at the client or may just include new state information obtained during the current session. Next a confirmation of the sent state information is received (step 702). State information is cleaned or erased from the client (step 704). This step is an optional step and prevents cluttering or unauthorized use of state information for a particular user. The browser is then closed (step 706) with the process terminating thereafter.

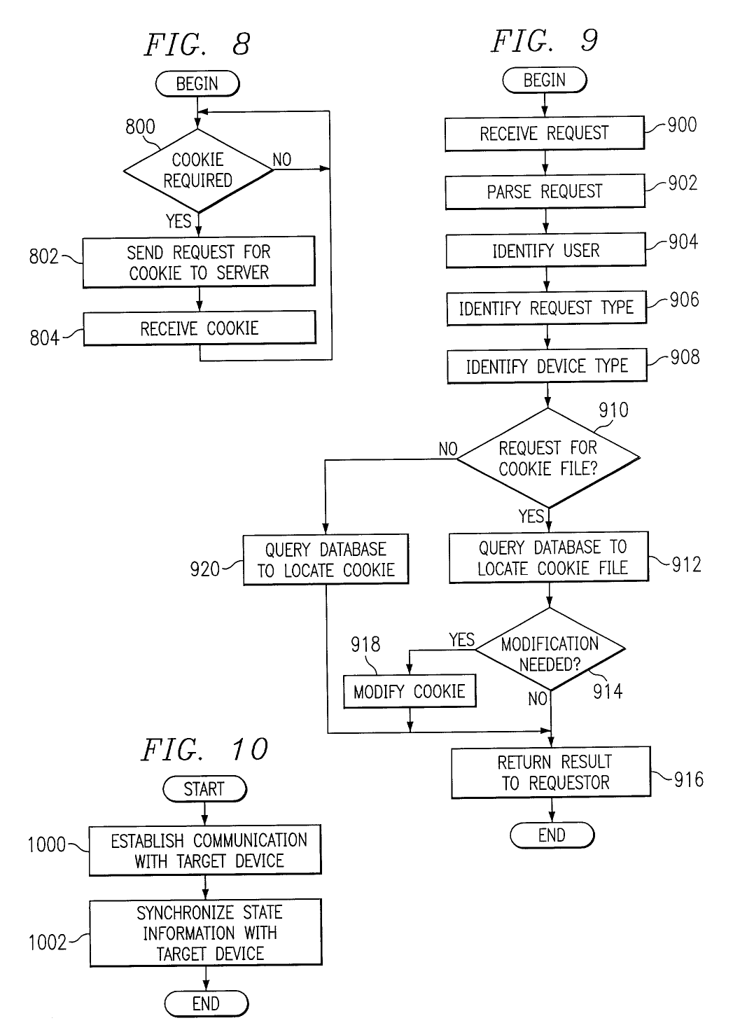

Turning next to FIG. 8, a flowchart of a process used for retrieving a cookie is depicted in accordance with a preferred embodiment of the present invention. The process illustrated in FIG. 8 may be implemented in an application, such as browser 508 in FIG. 5. This process illustrates requesting portions of state information stored at a server.

The process begins with a determination as to whether a cookie is required (step 800). If no cookie is required, the process returns to step 800. Otherwise, a request for the cookie is sent to a server (step 802). A cookie is received (step 804) and the process returns to step 800 as described above.

With reference next to FIG. 9, a flowchart of a process used for processing a request for a cookie file is depicted in accordance with a preferred embodiment of the present invention. The process illustrated in FIG. 9, may be in a server, such as Web server 5 in FIG. 5.

The process begins by receiving a request for state information (step 900). In these examples, the state information is for one or more cookies. The request is then parsed (step 902), and a user is identified (step 904). The user may be identified in a number of different ways. For example, the user may be identified through an ID located within the request. Next, the request type is identified (step 906), and a device type is identified (step 908). A determination is then made as to whether there has been a request for a cookie file based on the request type identified from the request (step 910). If a request for a cookie file has been made, a database is queried to locate the cookie file (step 912). Then, a determination is made as to whether a modification of the information is needed (step 914). Modifications to the information may be needed to enable the device to use the cookie. For example, if the user was previously at a workstation and has now moved to a mobile device, such as a PDA, then the information in cookies must be modified to reflect the difference in capability if this information is present within cookies. If a cookie contains graphics and video information about a device, then this information must be modified to match that of the PDA rather than that of the workstation. Similar modification of the cookies contain other device specific information, such as storage capability or sound capability. If a modification is not needed, the result of the query is returned to the user (step 916) with the process terminating thereafter.

With reference again to step 914, if a modification is required, then the information is modified for use with the device (step 918) with the process then proceeding to step 916 as described above. Turning back to step 910, if the request is not for a cookie file, it is assumed that the request is for a particular cookie and the database is queried to locate the desired cookie (step 920) with the process then proceeding the step 916 as described above.

Turning now to FIG. 10, a flowchart of a process used for synchronizing state information is depicted in accordance with a preferred embodiment of the present invention. The process illustrated in FIG. 10 may be implemented in an application, such as browser 508 in FIG. 5.

The process begins by establishing a communication with a target device (step 1000). For example, a user carrying a PDA may establish a communications link with the user's home computer to obtain state information for use with the PDA. Next the state information is synchronized with the target device (step 1002) with the process terminating thereafter. In this manner, the user may obtain current state information from another device. Further, this synchronization process may be used between different users to share state information, such as, for example, a list of bookmarks.

Thus, the present invention provides an improved method, apparatus, and computer implemented instructions for maintaining and transferring state information for users at multiple devices by storing the state information at a server or other type of depository. This state information may be transmitted to the next device for use by the user. The mechanism used to exchange information may be used through a protocol, such as HTTP, or a general purpose exchange mechanism, such as e-mail.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, state information is illustrated as being transferred between clients, such as computers containing browsers. This information also may be transferred to other devices, such as a smart card. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing cookies, the method comprising:
responsive to a selected event, requesting a cookie file from a source, wherein the cookie file contains a set of cookies of previously obtained cookies and is associated with a user; and
receiving the cookie file, wherein the cookies are to access Web sites.

2. The method of claim 1 wherein the selected event is a first selected event and further comprising:
updating the cookie file during a browser session to form an updated cookie file; and
responsive to a second selected event, sending the updated cookie file to a source.

3. The method of claim 1, wherein the source is at least one of a server, a desktop computer, a personal digital assistant, and a mobile phone

4. The method of claim 1, wherein the selected event is one of a beginning of a browser session or a particular user input.

5. The method of claim 2, wherein the first selected event is a beginning of the browser session and the second selected event is a termination of the browser session.

6. The method of claim 1, wherein the selected event is a requirement of a cookie to access a Web site.

7. The method of claim 1, wherein the cookie file includes access information.

8. The method of claim 1, wherein the cookie file includes authorization data.

9. The method of claim 1 further comprising:
selectively modifying data within the cookie file for use with the data processing system.

10. The method of claim 1, wherein the data processing system is one of a laptop computer, a personal digital assistant, a mobile phone, or a smart card.

11. The method of claim 1, wherein the cookie file is received using a wireless communications link.

12. The method of claim 1, wherein the cookie file includes information on at least one of sales transactions, user preferences, a history of Web sites visited by a user.

13. A method in a data processing system for managing cookies, the method comprising:
receiving a request for a cookie file;
parsing the request to identify a user associated with the cookie file;
identifying a particular cookie file associated with the user; and
transmitting the particular cookie file to the user.

14. The method of claim 13 further comprising:
receiving an updated cookie file for the user; and
storing the updated cookie file in association with the user.

15. The method of claim 13, wherein the user is identified by at least one of an Internet Protocol address and a user name in the request.

16. The method of claim 13 further comprising:
billing the user for maintaining the particular cookie file.

17. The method of claim 16, wherein billing is performed on one of a per access basis or a periodic basis.

18. The method of claim 14 further comprising:
selling the update cookie file.

19. A method in a data processing system for managing cookies, the method comprising:
monitoring for a requirement for a cookie to access a Web site;
responsive to detecting the requirement, sending a request for the cookie to a source storing the cookie obtained from a pervious access of the Web site by a user, wherein the request identifies the cookie and the user;
receiving the cookie to form a received cookie; and
accessing the Web site using the received cookie.

20. A data processing system comprising:
a state information repository, wherein state information is are maintained for users in the state information repository; and
a Web server, wherein the Web server monitors for requests for cookies from users and returns state information to the users when requests for state information are received.

21. The data processing system of claim 20, wherein the state information includes at least one of a cookie, a browsing history, and a bookmark.

22. A method in data processing system for managing state information, the method comprising:
responsive to an event, requesting state information from a source;
receiving the state information; and
using the state information to access data on a network data processing system.

23. The method of claim 22, wherein the event is a first event and further comprising:
altering the state information in response to accessing the network data processing system to form new state information; and
sending the new state information to the source in response to a second event.

24. The method of claim 22, wherein the state information includes at least one of a cookie, a history, and a bookmark.

25. A method in a data processing system for sharing state information, the method comprising:
maintaining a repository of state information for a set of users, wherein data within the state information files are user by the set of users to access information on other data processing systems; and
providing the a user from the set of users access to a state information file associated with the user to access other data processing systems.

26. The method of claim 25 further comprising:
selectively combining state information from state information files within the repository of state information files to form a new state information file.

27. The method of clam 26 further comprising:
offering the new state information file for sale to a third party.

28. The method of claim 25 further comprising:
billing the set of users for providing access the repository.

29. The method of claim 25 further comprising:
receiving updated information to a state information file within the repository from a user; and
updating the state information file with the updated information.

30. The method of claim 25, wherein the state information includes at least one of a cookie, a history, and a bookmark.

31. A data processing system comprising:
a bus system;
a communications unit connected to the bus system;
a memory connected to the bus system, wherein the memory includes as set of instructions; and
a processing unit connected to the bus system, wherein the processing unit executes the set of instructions to request a cookie file from a source, wherein the cookie file contains a set of cookies of previously obtained cookies and is associated with a user in response to a selected event; and receive the cookie file, wherein the cookies are to access Web sites.

32. A data processing system comprising:
a bus system;
a communications unit connected to the bus system;
a memory connected to the bus system, wherein the memory includes as set of instructions; and
a processing unit connected to the bus system, wherein the processing unit executes the set of instructions to receive a request for a cookie file; parse the request to identify a user associated with the cookie file; identify a particular cookie file associated with the user; and transmit the particular cookie file to the user.

33. A data processing system comprising:
a bus system;
a communications unit connected to the bus system;
a memory connected to the bus system, wherein the memory includes as set of instructions; and
a processing unit connected to the bus system, wherein the processing unit executes the set of instructions to monitor for a requirement for a cookie to access a Web site; send a request for the cookie to a source storing the cookie obtained from a pervious access of the Web site by a user, wherein the request identifies the cookie and the user in response to detecting the requirement; receive the cookie to form a received cookie; and access the Web site using the received cookie.

34. A data processing system comprising:
a bus system;
a communications unit connected to the bus system;
a memory connected to the bus system, wherein the memory includes as set of instructions; and
a processing unit connected to the bus system, wherein the processing unit executes the set of instructions to maintain a repository of cookies files for a set of users, wherein data within the cookie files are user by the set of users to access information on other data processing systems; and provide the a user from the set of users access to a cookie file associated with the user to access other data processing systems.

35. A data processing system comprising:
a bus system;
a communications unit connected to the bus system;
a memory connected to the bus system, wherein the memory includes as set of instructions; and
a processing unit connected to the bus system, wherein the processing unit executes the set of instructions to request state information from a source in response to an event; receive the state information; and use the state information to access data on a network data processing system.

36. A data processing system for managing cookies, the data processing system comprising:
requesting means, responsive to a selected event, for requesting a cookie file from a source, wherein the cookie file contains a set of cookies of previously obtained cookies and is associated with a user; and
receiving means for receiving the cookie file, wherein the cookies are to access Web sites.

37. The data processing system of claim 36 wherein the selected event is a first selected event and further comprising:
updating means for updating the cookie file during a browser session to form an updated cookie file; and
sending means, responsive to a second selected event, for sending the updated cookie file to a source.

38. The data processing system of claim 36, wherein the source is at least one of a server, a desktop computer, a personal digital assistant, and a mobile phone

39. The data processing system of claim 36, wherein the selected event is one of a beginning of a browser session or a particular user input.

40. The data processing system of claim 37, wherein the first selected event is a beginning of the browser session and the second selected event is a termination of the browser session.

41. The data processing system of claim 36, wherein the selected event is a requirement of a cookie to access a Web site.

42. The data processing system of claim 36, wherein the cookie file includes access information.

43. The data processing system of claim 36, wherein the cookie file includes authorization data.

44. The data processing system of claim 36 further comprising:
selectively means for selectively modifying data within the cookie file for use with the data processing system.

45. The data processing system of claim 36, wherein the data processing system is one of a laptop computer, a personal digital assistant, a mobile phone, or a smart card.

46. The data processing system of claim 36, wherein the cookie file is received using a wireless communications link.

47. The data processing system of claim 36, wherein the cookie file includes information on at least one of sales transactions, user preferences, a history of Web sites visited by a user.

48. A data processing system for managing cookies, the data processing system comprising:
receiving means for receiving a request for a cookie file;
parsing means for parsing the request to identify a user associated with the cookie file;
identifying means for identifying a particular cookie file associated with the user; and
transmitting means for transmitting the particular cookie file to the user.

49. The data processing system of claim 48, wherein the receiving means is a first receiving means and further comprising:
second receiving means for receiving an updated cookie file for the user; and
storing means for storing the updated cookie file in association with the user.

50. The data processing system of claim 48, wherein the user is identified by at least one of an Internet Protocol address and a user name in the request.

51. The data processing system of claim 48 further comprising:
billing means for billing the user for maintaining the particular cookie file.

52. The data processing system of claim 51, wherein billing is performed on one of a per access basis or a periodic basis.

53. The data processing system of claim 49 further comprising:
selling means for selling the update cookie file.

54. A data processing system for managing cookies, the data processing system comprising:
monitoring means for monitoring for a requirement for a cookie to access a Web site;
sending means responsive to detecting the requirement, for sending a request for the cookie to a source storing the cookie obtained from a pervious access of the Web site by a user, wherein the request identifies the cookie and the user;
receiving means for receiving the cookie to form a received cookie; and
accessing means for accessing the Web site using the received cookie.

55. A method in a data processing system for sharing state information, the method comprising:
maintaining means for maintaining a repository of state information for a set of users, wherein data within the state information files are user by the set of users to access information on other data processing systems; and
providing means for providing the a user from the set of users access to a state information file associated with the user to access other data processing systems.

56. The data processing system of claim 55 further comprising:
selectively means for selectively combining cookies from cookies files within the repository of cookies files to form a new cookie file.

57. The data processing system of clam 56 further comprising:
offering means for offering the new cookie file for sale to a third party.

58. The data processing system of claim 55 further comprising:
billing means for billing the set of users for providing access the repository.

59. The data processing system of claim 55 further comprising:
receiving means for receiving updated information to a cookie file within the repository from a user; and
updating means for updating the cookie file with the updated information.

60. A data processing system for managing state information, the method comprising:
requesting means, responsive to an event, for requesting state information from a source;
receiving means for receiving the state information; and
using means for using the state information to access data on a network data processing system.

61. The data processing system of claim 60, wherein the event is a first event and further comprising:
altering the state information in response to accessing the network data processing system to form new state information; and
sending the new state information to the source in response to a second event.

62. The data processing system of claim 60, wherein the state information includes at least one of a cookie, a history, and a bookmark.

63. A computer program product in a computer readable medium for managing cookies, the computer program product comprising:
first instructions, responsive to a selected event, for requesting a cookie file from a source, wherein the cookie file contains a set of cookies of previously obtained cookies and is associated with a user; and
second instructions for receiving the cookie file, wherein the cookies are to access Web sites.

64. The computer program product of claim 63 wherein the selected event is a first selected event and further comprising:
third instructions for updating the cookie file during a browser session to form an updated cookie file; and
fourth instructions, responsive to a second selected event, for sending the updated cookie file to a source.

65. The computer program product of claim 63, wherein the source is at least one of a server, a desktop computer, a personal digital assistant, and a mobile phone

66. The computer program product of claim 63, wherein the selected event is one of a beginning of a browser session or a particular user input.

67. The computer program product of claim 64, wherein the first selected event is a beginning of the browser session and the second selected event is a termination of the browser session.

68. The computer program product of claim 63, wherein the selected event is a requirement of a cookie to access a Web site.

69. The computer program product of claim 63, wherein the cookie file includes access information.

70. The computer program product of claim 63, wherein the cookie file includes authorization data.

71. The computer program product of claim 63 further comprising:
third instructions for selectively modifying data within the cookie file for use with the data processing system.

72. The computer program product of claim 63, wherein the data processing system is one of a laptop computer, a personal digital assistant, a mobile phone, or a smart card.

73. The computer program product of claim 63, wherein the cookie file is received using a wireless communications link.

74. The computer program product of claim 63, wherein the cookie file includes information on at least one of sales transactions, user preferences, a history of Web sites visited by a user.

75. A computer program product in a computer readable medium for managing cookies, the computer program product comprising:
first instructions for receiving a request for a cookie file;
second instructions for parsing the request to identify a user associated with the cookie file;
third instructions for identifying a particular cookie file associated with the user; and
fourth instructions for transmitting the particular cookie file to the user.

76. The computer program product of claim 75 further comprising:
fifth instructions for receiving an updated cookie file for the user; and
sixth instructions for storing the updated cookie file in association with the user.

77. The computer program product of claim 75, wherein the user is identified by at least one of an Internet Protocol address and a user name in the request.

78. The computer program product of claim 75 further comprising:
fifth instructions for billing the user for maintaining the particular cookie file.

79. The computer program product of claim 78, wherein billing is performed on one of a per access basis or a periodic basis.

80. The computer program product of claim 76 further comprising:
fifth instructions for selling the update cookie file.

81. A computer program product in a computer readable medium for managing cookies, the computer program product comprising:
first instructions for monitoring for a requirement for a cookie to access a Web site;
second instructions, responsive to detecting the requirement, for sending a request for the cookie to a source storing the cookie obtained from a pervious access of the Web site by a user, wherein the request identifies the cookie and the user;
third instructions for receiving the cookie to form a received cookie; and
fourth instructions for accessing the Web site using the received cookie.

82. A computer program product in a computer readable medium for sharing state information, the computer program product comprising:
first instructions for maintaining a repository of cookies files for a set of users, wherein data within the cookie files are user by the set of users to access information on other data processing systems;
second instructions for providing the a user from the set of users access to a cookie file associated with the user to access other data processing systems.

83. The computer program product of claim 82 further comprising:
third instructions for selectively combining cookies from cookies files within the repository of cookies files to form a new cookie file.

84. The computer program product of clam 83 further comprising:
fourth instructions for offering the new cookie file for sale to a third party.

85. The computer program product of claim 82 further comprising:
third instructions for billing the set of users for providing access the repository.

86. The computer program product of claim 82 further comprising:
third instructions for receiving updated information to a cookie file within the repository from a user; and
fourth instructions for updating the cookie file with the updated information.

87. A computer program product in a compute r readable medium for managing state information, the computer program product comprising:
first instructions, responsive to an event, for requesting state information from a source;
second instructions for receiving the state information; and
third instructions for using the state information to access data on a network data processing system.

88. The computer program product of claim 87, wherein the event is a first event and further comprising:
fourth instructions for altering the state information in response to accessing the network data processing system to form new state information; and
fifth instructions for sending the new state information to the source in response to a second event.

89. The computer program product of claim 87, wherein the state information includes at least one of a cookie, a history, and a bookmark.
